(19) United States
(12) Patent Application Publication
(10) Pub. No.: US 2013/0092049 A1
(43) Pub. Date: Apr. 18, 2013

(54) WHITE INORGANIC COATING COMPOSITION, AND DEVICE EMPLOYING A COATING MADE OF THE COMPOSITION

(71) Applicants: Kun-Mu Lee, Beigang Township (TW); Chin-Ching Lin, Taichung City (TW); Mei-Ching Chiang, Shulin City (TW); Yu-Chun Chen, Zhongli City (TW); Chyi-Ming Leu, Jhudong Township (TW)

(72) Inventors: Kun-Mu Lee, Beigang Township (TW); Chin-Ching Lin, Taichung City (TW); Mei-Ching Chiang, Shulin City (TW); Yu-Chun Chen, Zhongli City (TW); Chyi-Ming Leu, Jhudong Township (TW)

(21) Appl. No.: 13/359,566

(22) Filed: Jan. 27, 2012

(30) Foreign Application Priority Data
Oct. 12, 2011 (TW) 100136887

(51) Int. Cl. C09D 101/00; C09D 1/00; B82Y 30/00

(52) U.S. Cl. 106/204.2; 106/286.4; 977/773

(57) ABSTRACT

The disclosure provides a white inorganic coating composition, and a device employing a coating made of the composition. The white inorganic coating composition includes a first inorganic material with a refractive index of less than 1.6, a second inorganic material with a refractive index of more than 2.3, and an inorganic blue pigment.

### CROSS REFERENCE TO RELATED APPILCATIONS

This application is based upon and claims the benefit of priority from the prior Taiwan Patent Application No. 100136887, filed on Oct. 12, 2011, the entire contents of which are incorporated herein by reference.

### BACKGROUND

1. Technical Field

The disclosure relates to a white coating composition, and in particular relates to a white inorganic coating composition.

2. Related Art

With the development of technology, since designs of display devices are moving toward being miniaturized, light, and thin, it is desirable to reduce the use of glass substrates. Therefore, smart phones, table PCs, digital photo frames, electronic books, and other portable devices are apt to employ a single piece of glass substrate in order to reduce the weight and thickness thereof.

In the fabrication of a device having a single piece of glass, a frame is provided first, and then the frame is subjected to subsequent processes such as etching or wiring processes. If the frame is coated by a white pigment, the frame would be degraded by high temperatures during the subsequent processes, resulting in yellowing. In general, the white coating used in a display device is made of a composition including organic polymer and white dye. The white coating is susceptible to yellowing when heated to 300° C. Therefore, the conventional white coating is not suitable for use in the fabrication of the device having a single piece of glass.

Currently, a white coating composition with inorganic compounds has been developed to solve the aforementioned problems. For example, the coating composition includes a titanium oxide mixed with a resin. The coating composition, however, would also be degraded during a process with a process temperature of between 300-400° C., since the resin would decompose under such conditions.

Alternately, an inorganic white coating composition is also provided to solve the aforementioned problems. However, since the conventional inorganic white coating composition should be further sintered at 800° C., the display device would not bear the ultra-high temperature, and elements of the display device would be damaged.

Accordingly, a novel white coating composition suitable for the fabrication of display device having single piece of glass is desired.

### SUMMARY

The disclosure provides a white inorganic coating composition, including: a first inorganic material with a refractive index of less than 1.6; a second inorganic material, with a refractive index of more than 2.3; and an inorganic blue pigment.

According to another embodiment of the disclosure, a device is also provided, wherein the device includes a substrate; and a white coating disposed on the substrate, wherein the white coating is formed by the aforementioned white inorganic coating composition.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1 and 2 are a series of cross-section views showing devices employing the coating formed by the white inorganic coating compositions of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides a white inorganic coating composition and a device employing a coating formed by the white inorganic coating composition. According to an embodiment of the disclosure, the white inorganic coating composition includes a first inorganic material, wherein the first inorganic material has a refractive index of less than 1.6; a second inorganic material, wherein the second inorganic material has a refractive index of more than 2.3; and an inorganic blue pigment. Particularly, the first inorganic material can be a low-melting glass. The low-melting glass can be a low-melting glass frit which has a softening point of between 300-600° C. and can be sintered at a temperature of less than 600° C. The low-melting glass frit includes mainly silicon oxide and can further include lead oxide, boron oxide, aluminum oxide, bismuth oxide, or combinations thereof. In general, the second inorganic material can has a particular size of between 100-500 nm. According to another embodiment of the disclosure, the second inorganic material can consist of first and second inorganic particles, wherein the first inorganic particle has a particular size of between 200-500 nm, and the second inorganic particle has a particular size of between 1-100 nm. Moreover, the inorganic blue pigment can be ultramarine, cobalt blue, iron blue, or combinations thereof.

In order to improve the film-forming ability of the obtained coating, the white inorganic coating composition includes the first inorganic material such as a low-melting glass. On the other hand, the second inorganic material with high refractive index can reduce the light transparency of the composition, resulting in the obtained coating to have a white appearance.

In the white inorganic coating composition of the disclosure, the first inorganic material can have a weight percentage of between 15-85 wt %, and the second inorganic material can have a weight percentage of between 15-85 wt %, based on the total weight of the first inorganic material and the second inorganic material. If the first inorganic material has a weight percentage of less than 15 wt % and the second inorganic material has a weight percentage of more than 85 wt %, the composition would have an inferior film-forming ability. To the contrary, if the first inorganic material has a weight percentage of more than 85 wt % and the second inorganic material has a weight percentage of less than 15 wt %, the coating would not have a white appearance due to the high transparency thereof. Further, since the composition includes the low-melting glass, the obtained coating is apt to have a yellowish appearance in general. Therefore, the white inorganic coating composition of the disclosure further includes an inorganic blue pigment for modifying the color of the coating.

After coating the composition to a substrate, a sintering process is sequentially performed to form a white coating, wherein the sintering process has a process temperature of between 400-600° C. Accordingly, the white inorganic coating composition includes an inorganic blue pigment, rather than an organic blue pigment. The inorganic blue pigment can have a weight percentage of between 0.1-1.5 wt %, based on the total weight of the first inorganic material and the second inorganic material. It should be noted that, since a slurry including the first inorganic material and the second inorganic material has a yellow fluorescent color, the inorganic blue pigment is used to harmonize the color of the slurry. If the inorganic blue pigment has a weight percentage of less than 0.1 wt %, the obtained coating would have a yellowish appearance. If the inorganic blue pigment has a weight percentage of more than 1.5 wt %, the obtained coating would have a bluish appearance.

According to another embodiment of the disclosure, in order to form a coating via screen printing with the white inorganic coating composition, the white inorganic coating composition can further include a thickening agent to modify the viscosity of the composition. The thickening agent can be ethyl cellulose, hydroxyethyl cellulose, hydroxypropyl cellulose, methyl cellulose, carboxymethyl cellulose, or combinations thereof. Further, the thickening agent can be further dissolved into a solvent such as terpineol for addition into the composition. The thickening agent has a weight percentage of between 1-50 wt %, based on the total weight of the first inorganic material and the second inorganic material.

The white inorganic coating composition of the disclosure mainly includes inorganic compounds rather than organic compounds of a conventional white coating composition. The coating fabricated by the white inorganic coating composition exhibits a high thermal resistance (achieving to 400° C.) and is not apt to yellowing. Further, the aforementioned coating has high tolerance against variations in subsequent processes and can be suitable for serving as a paint for a display device.

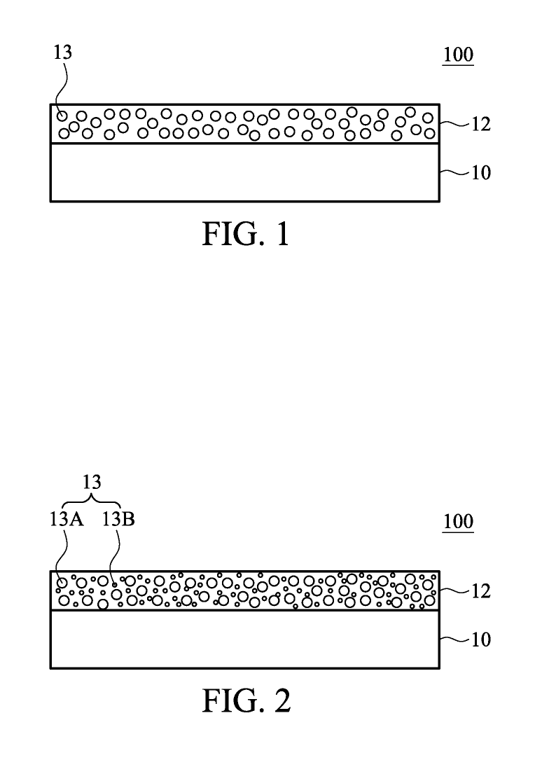

According to some embodiments of the disclosure, the disclosure provides a device, such as a display device, a mobile device, or an optical film. Referring to FIG. 1, the device 100 can include a substrate 10; and a white coating 12 disposed on substrate 10, wherein the white coating 12 is formed by coating and sintering the white inorganic coating composition. The white coating 12 includes inorganic particles 13 (such as titanium oxide, zirconium dioxide, or aluminium oxide) with high refractive index.

The inorganic particles 13 (such as titanium oxide, zirconium dioxide, or aluminium oxide) with high refractive index can have a fixed particular size (as shown in FIG. 1). Further, the inorganic particles 13 can consist of a first inorganic particle 13A with a relatively larger particular size and a second inorganic particle 13B with a relatively smaller particular size (as shown in FIG. 2). Meanwhile, the inorganic particle 13B with relatively smaller particular sizes can serve as connecting points for improving the film-forming ability. The white coating of the disclosure has an optical density (OD) of between 0.5-4.0 and a pencil hardness of more than 3H.

The following examples are intended to illustrate the invention more fully without limiting their scope, since numerous modifications and variations will be apparent to those skilled in this art.

Preparation of White Inorganic Coating Composition

### Example 1

10 g of TiO₂ (sold by Rutile), 10 g of a low-melting glass (including silicon oxide, lead oxide, and aluminum oxide, sold by NIPPON ELECTRIC GLASS CO., LTD.), and 0.1 g of ultramarine were mixed to obtain a mixture. Next, a solution (including 10 g of ethyl cellulose and 70 g of terpineol) was further added into the mixture to increase the Viscosity for screen printing, obtaining a white inorganic coating composition (1).

### Example 2

Example 2 was performed in the same manner as in Example 1 except that 17 g of TiO₂ and 3 g of a low-melting glass were used instead of the amounts in Example 1, obtaining a white inorganic coating composition (2).

### Example 3

Example 3 was performed in the same manner as in Example 1 except that 3 g of TiO₂ and 17 g of a low-melting glass were used instead of the amounts in Example 1, obtaining a white inorganic coating composition (3).

Preparation of White Coatings

### Example 4

The white inorganic coating compositions (1)-(3) of Examples 1-3 were respectively coated to a glass substrate via screen printing with a thickness of 19 μm. After baking at 100° C. and sintering at 500° C. for 30 min, white coatings (1)-(3) were respectively obtained.

Measurement of White Coatings

### Example 5

The white coating (2) of Example 4 was subjected to an optical density measurement and a chromaticity measurement, and the results are shown in Table 1. Next, the coating (2) of Example 4 was subjected to a thermal treatment (baked at a temperature of 350° C. for 30 min). After the thermal treatment, the coating (2) of Example 4 was subjected to an optical density measurement and a chromaticity measurement again, and the results are shown in Table 1.

TABLE 1

| | | white coating (2) | |
|---|---|---|---|
| | | Before treatment | After treatment |
| OD | | 1.05 | 1.05 |
| chromaticity | L* | 84.09 | 84.49 |
| | a* | −0.17 | −0.05 |
| | b* | 0.84 | 1.07 |

### Comparative Example 1

A white coating composition (commercially available from Rainbowpaint CO., LTD. with a trade number of NO.1509) was coated to a glass substrate via screen printing, and then baked at 150° C. for 1 hr, forming a coating. The coating was subjected to an optical density measurement, and the coating has an optical density value of 1.05. Next, the coating was subjected to a thermal treatment (baked at a temperature of 350° C. for 30 min), and some defects such as peeling and yellowing of the coating were observed.

According to Table 1 and Comparative Example 1, since the optical density and chromaticity are approximately constant before and after the thermal treatment, the coating prepared by the white inorganic coating composition of the disclosure has high thermal stability, which is suitable for application in display or mobile devices to solve the degrading problems of conventional white coatings.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A white inorganic coating composition, comprising:
a first inorganic material with a refractive index of less than 1.6;
a second inorganic material, with a refractive index of more than 2.3; and
an inorganic blue pigment.

2. The white inorganic coating composition as claimed in claim 1, wherein the first inorganic material is a low-melting glass.

3. The white inorganic coating composition as claimed in claim 2, wherein the low-melting glass comprises silicon oxide, lead oxide, boron oxide, aluminum oxide, bismuth oxide, or combinations thereof.

4. The white inorganic coating composition as claimed in claim 1, wherein the second inorganic material comprises titanium oxide, zirconium dioxide, or combinations thereof.

5. The white inorganic coating composition as claimed in claim 1, wherein the second inorganic material has a particular size of between 100-500 nm.

6. The white inorganic coating composition as claimed in claim 1, wherein the second inorganic material consists of first and second inorganic particles, and wherein the first inorganic particle has a particular size of between 200-500 nm, and the second inorganic particle has a particular size of between 1-100 nm.

7. The white inorganic coating composition as claimed in claim 1, wherein the inorganic blue pigment comprises ultramarine, cobalt blue, iron blue, or combinations thereof.

8. The white inorganic coating composition as claimed in claim 1, wherein the first inorganic material has a weight percentage of between 15-85 wt %, and the second inorganic material has a weight percentage of between 15-85 wt %, based on the total weight of the first inorganic material and the second inorganic material.

9. The white inorganic coating composition as claimed in claim 1, wherein the inorganic blue pigment has a weight percentage of between 0.1-1.5 wt %, based on the total weight of the first inorganic material and the second inorganic material.

10. The white inorganic coating composition as claimed in claim 1, further comprising a thickening agent.

11. The white inorganic coating composition as claimed in claim 10, wherein the thickening agent comprises ethyl cellulose, hydroxyethyl cellulose, hydroxypropyl cellulose, methyl cellulose, carboxymethyl cellulose, or combinations thereof.

12. The white inorganic coating composition as claimed in claim 10, wherein the thickening agent has a weight percentage of between 1-50 wt %, based on the total weight of the first inorganic material and the second inorganic material.

13. A device, comprising:
a substrate; and
a white coating disposed on the substrate, wherein the white coating is formed by the white inorganic coating composition as claimed in claim 1.
